(19) United States
(12) Patent Application Publication
(10) Pub. No.: US 2017/0127361 A1
(43) Pub. Date: May 4, 2017

(54) System and Software for Interlinking Responses of Mobile Cellular Devices to Create a Communal Response to a Single Directive

(71) Applicants: Brian Zima, Upper Saddle River, NJ (US); Seth Damergy, Hoboken, NJ (US)

(72) Inventors: Brian Zima, Upper Saddle River, NJ (US); Seth Damergy, Hoboken, NJ (US)

(21) Appl. No.: 15/340,967

(22) Filed: Nov. 1, 2016

Related U.S. Application Data
(60) Provisional application No. 62/249,908, filed on Nov. 2, 2015.

(51) Int. Cl. H04W 56/00; H04W 4/08; H04L 29/08

(52) U.S. Cl. CPC H04W 56/00; H04L 67/34; H04W 4/08; H04L 67/141; G06F 3/0482

(57) ABSTRACT

The present invention is a system and method of operating cellular devices in a synchronized manner. Each of the plurality of mobile cellular devices has a system clock, a display screen, a camera flash, and communicates with a communications network. A software application is loaded onto each cellular devices. A lead user selects a session activity that is to be performed by the cellular devices. The cellular devices first update system time to improved time synchronization. At an execution time, a session activity is performed simultaneously by all the mobile cellular devices.

### RELATED APPLICATIONS

This application claims the benefit of provisional application No. 62/249,908 filed Nov. 2, 2015.

### BACKGROUND OF THE INVENTION

1. Field of the Invention

In general, the present invention relates to systems and software that enable a single person to communicate with multiple cell phones simultaneously, over a communications network. More particularly, the present invention relates to systems that enable one cell phone to solicit a time-synchronized response from a multitude of other cell phones in remote locations.

2. Prior Art Description

It is very easy to synchronize the movements and actions of just a few people. For instance, it is easy to get a few people to clap together in unison. However, trouble occurs when attempts are made to synchronize large numbers of people. For instance, it is nearly impossible for get a stadium filled with people to clap in unison. This is because each person in the stadium may hear the direction to clap at a slightly different time, due to transmission delays. People also hear other people clap who are far enough away that the sound is delayed by the distance the sound travels. Furthermore, some people have faster reaction times than do other people and may clap at a different rate. Each of these circumstances causes a slight difference in a person's reaction time. These slight delays in reactions cause different parts of a crowd to quickly fall out of synchronization. Therefore, after only a few claps, any attempt at synchronization is lost to random applause.

The same problems occur when a person attempts to coordinate a crowd using messages that are broadcast over a communications network. Different people have different phones with different clock setting and networks that send data at different rates. As such, any attempt to synchronize a crowd of people using instructions sent to the phones of the individuals in the crowd are destined to be out of synchronization.

In the prior art, attempts have been made to provide better synchronization to multiple cell phones. For example, in U.S. Patent Application Publication No. 2012/0165100 to Lalancette, a system is disclosed where activities are synchronized at the server. This helps somewhat. However, different cell phones access the synchronized server in different ways, using different cellular providers and transmitting to different cell towers at different distances from the cell towers. The result is a difference in synchronization at each phone as great as a few seconds.

In U.S. Pat. No. 7,697,925 to Wilson, a cell phone display system is disclosed that causes different cell phones to run software commands at the each same chronological time. For example, all of the cell phone can be made to have a white screen at exactly 12 noon. This eliminates delays caused by data transmission. However, the problem is that each cell phone participating does not have its internal clock synchronized with the other phones in the system. As a result, the internal clock of the phone can often be a fraction of a second different from the internal clock of other phones. The difference in internal time may be as great as two seconds.

Having phones synchronized to less than one second may be fine for coordinating the singing of a song. However, such an error in synchronization is very troublesome in other applications. Suppose a person is trying to get cell phones to all flash at the exact same time. The flash of a cell phone camera only lasts a fraction of a second. If the phones are out of synchronization by a fraction of a second, the result is that all the phones will not flash at the exact same moment in time. Rather, some phones will flash slightly early and some phones will flash slightly late. The result is one long flash rather than one intense short flash. The same problem occurs when a large crowd claps, chants or cheers in unison. A flaw in synchronization of only a fraction of a second will create a cumulative delay that will act to quickly disrupt any synchronization that may exist.

The need for exact synchronization between cell phones becomes even more important if the action being attempted has a change cycle of less than one second. For example, suppose a grouping of cell phones are being used as pixels to create a much larger overall display in a crowd of cell phone users. By synchronizing the displays, the image can be manipulated in a controlled manner. However, if the cell phone synchronization is off by only a fraction of a second, the integrity of the overall image is compromised.

A need therefore exists for a system and method that can be used to synchronize and control a large number of mobile cellular devices with a high degree of precision. In this manner, actions can be coordinated among all the mobile cellular devices that start and remain synchronized throughout the duration of the action. This need is met by the present invention as described and claimed below.

### SUMMARY OF THE INVENTION

The present invention is a system and method of operating a plurality of mobile cellular devices held by different users in a synchronized manner. Each of the plurality of mobile cellular devices has a system clock, a display screen, a camera flash, and exchange data with a communications network. A software application is loaded onto each of the mobile cellular devices. A lead user selects a session activity that is to be performed by a plurality of mobile cellular devices during an event.

The software application is run by the mobile cellular devices. Upon running the software application, each of the mobile cellular devices first updates its system time through the communications network. This creates improved time synchronization between each system clock in the plurality of mobile cellular devices. The software application enables each of the users to agree to participate in the session activity and become part of a user pool. The software application enables the lead user to set an execution time for the session activity elected.

At the execution time, the session activity is performed simultaneously by all the mobile cellular devices that are operated by users in the user pool.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a schematic showing the requirements of the present invention system and software;

FIG. 2 is a block diagram showing the program methodology used to update system times in participating mobile cellular devices;

FIG. 3 is a block diagram showing the methodology of the present invention system;

FIG. 4 shows an array of four cell phones flashing in unison;

FIG. 5 shows an array of four cell phones creating different parts of a single image; and

FIG. 6 shows an array of four cell phones prompting synchronized responses.

### DETAILED DESCRIPTION OF THE DRAWINGS

Although the present invention system and software can be embodied in many ways to conduct a wide array of actions, only a few such actions have been selected for illustration and discussion. The illustrated embodiments are merely exemplary and should not be considered limitations when interpreting the scope of the appended claims.

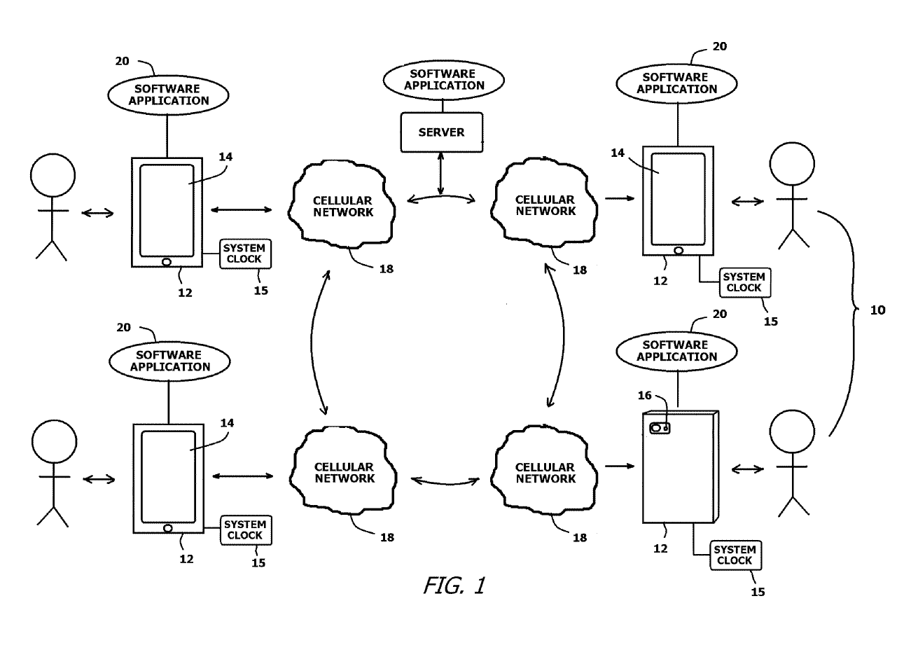

Referring to FIG. 1, the system requirements of the present invention system and software are disclosed. The system and software is run by software users 10. Each member of the software users 10 has a mobile cellular device 12. The mobile cellular device 12 is preferably a smart phone that has a display screen 14 and an integrated camera with a flash 16. Furthermore, each mobile cellular device 12 is built with an internal system clock 15. Depending upon the user history, the system clocks 15 of various mobile cellular devices 12 are typically off by a significant fraction of a second and may be off by up to two seconds.

Each software user 10 has a cell phone service provider that enables the mobile cellular device 12 to send and receive data over a particular communications network 18. The communications networks 18 exchange data among themselves in the traditional manner.

Each software user 10 downloads a software application 20. The software application 20 enables one person to transmit and coordinate an executable program to every member of the participating user crowd, as will be explained. The executable programs are received by the software users 10 in an unsynchronized manner. This is primarily due to transmission delays inherent in the various communications networks 18.

Each internal system clock 15 in each of the mobile cellular devices 12 maintains a system time. In computer programming, system time represents the internal clock used by the computer system to measure the passing of time. System time is measured by the system clock 15, which is typically implemented as a simple count of the number of ticks that have transpired since some arbitrary starting point. The starting point is called the epoch. Different mobile cellular devices use different epochs. For example, Unix® and POSIX® compliant systems encode system time (“Unix time”) as the number of seconds elapsed since the start of the Unix® epoch at 1 Jan. 1970 00:00:00, with exceptions for leap seconds. Systems that implement the 32-bit and 64-bit versions of the Windows® API, such as Windows® 9x and Windows® NT, provide the system time as both SYSTEMTIME, represented as a year/month/day/hour/minute/second/milliseconds value, since 1 Jan. 1601 00:00:00. Most iPhones® by Apple® use an epoch of 1 Jan. 1904, represented as a year/month/day/hour/minute/second/milliseconds value.

When a computer system first starts, it sets the system time to a value based on the real-time clock of the computer. The system time is regularly updated, such as each time the mobile cellular device 12 is powered on from a powered-off condition. However, many users rarely power off their mobile cellular devices 12. The clock circuitry within the mobile cellular devices therefore keeps the time between updates. Due to variations in the clock circuitry, errors in time occur. The errors in time are usually small, such as a fraction of a second per day. However, after only a short prior of time, two mobile cellular devices can have internal times that differ by one or two seconds. Errors in time accounting accumulate between updates. Modern mobile cellular devices 12 are programmed with a “GetSystemTime” function. When the mobile cellular device 12 is powered on, it searches for networks and runs the GetSystemTime function. When the GetSystemTime function is activated, the mobile cellular device 12 will communicate with a remote SYSTEMTIME structure that contains the current time in milliseconds for the epoch being used. The internal system clock 15 is then updated.

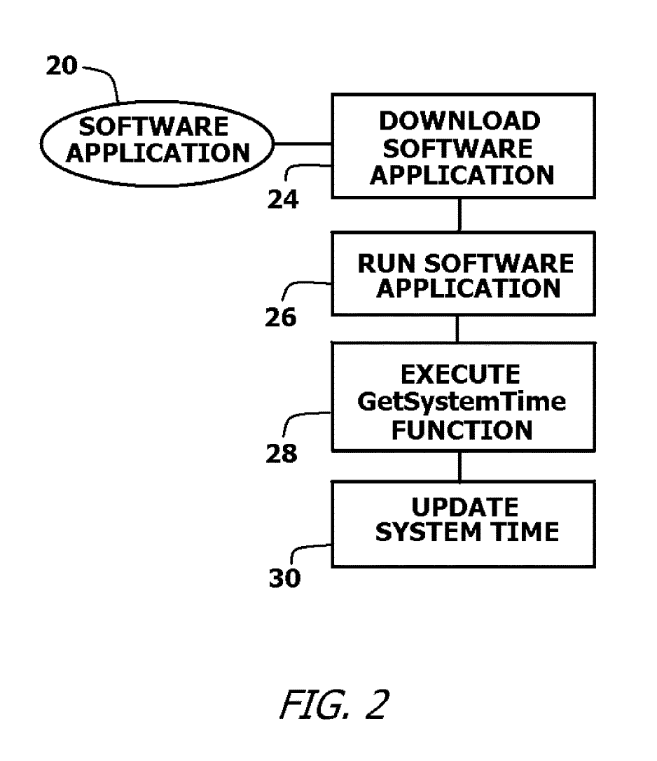

Referring to FIG. 2 in conjunction with FIG. 1, it will be understood that each of the software users 10 downloads the software application 20 from a remote server 22 in an unsynchronized manner. See Block 24. When each of the users 10 runs the software application 20, the software application 20 first automatically executes a GetSystemTime function. See Block 26 and Block 28. This causes each of the mobile cellular devices 12 to update its system time. See Block 30. Although the mobile cellular devices 12 may be different makes and models and may use different system time epochs, the updated system time for cellular networks are maintained on remote atomic clocks and will only vary by a few milliseconds, if at all. This is well within the operational parameters needed for the software application 20 to operate correctly.

All of the mobile cellular devices 12 that are running the software application 10, therefore, have system clocks 15 that are synchronized to within a few milliseconds. This is true of the mobile cellular devices 12 regardless of whether the mobile cellular devices 12 are together or are positioned on opposite sides of the globe.

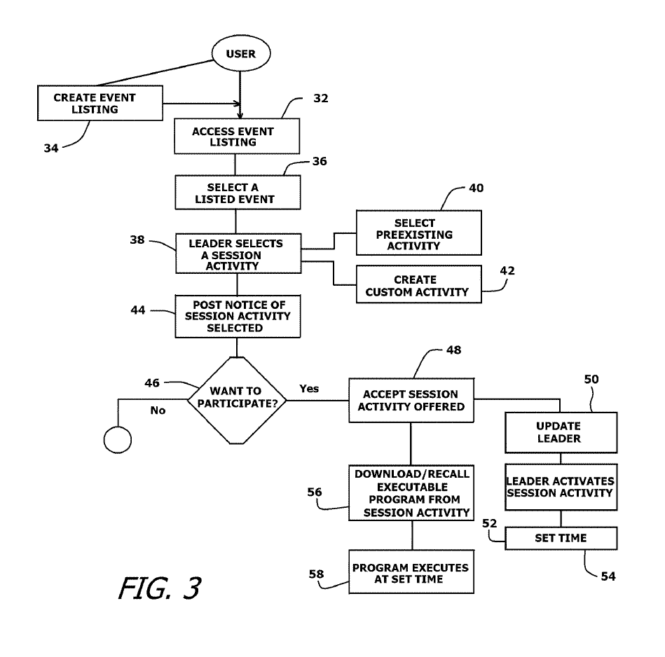

Referring to FIG. 3 in conjunction with FIG. 1, it can be seen that any of the software users 10 can create and post a crowd activity for a listed event. First, a software user 10 accesses a menu of listed events. See Block 32. If an event is a popular event such as a professional or collegic sporting event, then the event may be downloaded from the server 22 and listed. The server 22 can retrieve the event information from a team website or public schedule. If the event to be listed is a small affair, such as a child's soccer game, then the event listing is created by a software user 10. Once the event is created, the event is listed. See Block 34. Preferably, the events are not listed together. Rather, events are listed by areas of interest on various virtual billboards. In this manner, the event listing is easily found by software users 10 with the same interests who would visit that billboard. For example, in the case of a little league team, a billboard would be created for that little league team so parents and siblings can find the listings for that team in an efficient manner.

The software users 10 select a listed event. See Block 36. Once a software user 10 is running the software application 20 and selects a listed event, that software user 10 is considered part of the available user pool for that event. Thus, the user pool can be a few people for small listed events or many thousands of people for large popular events. Any one of the software users 10 in the event user pool can become a leader. To become a leader, a software user 10, or a group of users, selects a session activity. See Block 38. The session activity can be selected from a menu of preexisting session activities. See Block 40. Alternatively, the session activity can be a custom session activity designed and built by a software user 10. See Block 42. The session activity is an activity that is accomplished using the display screen 14, flash 16 and/or internal vibrator of the mobile cellular devices 12. The session activity can be a running display of a cheer, a chant, or a song. The session activity can be a series of screen images, a series of light flashes, the playing of audio, and/or a series of phone vibrations.

Once a leader or a leadership group selects a session activity, each of the software users 10 in the user pool gets a notice that a session activity has been posted. See Block 44. The software users 10 in the user pool are provided with enough information that they can determine what type of session activity has been offered by a particular leader or leadership group. The software users 10 in the user pool can ignore the notice if they do not want to participate in the offered session activity. See Block 46. If a software user 10 wants to participate, the user accepts the offered session activity. See Block 48.

The leader, or leadership group, who posted the session activity is updated and can see how many software users 10 from the user pool are prepared to participate. See Block 50. If enough software users 10 are participating, then the leader, or leadership group, can activate the session activity. See Block 52.

Once a session activity is activated, a time is selected to start the session activity. See Block 54. That time can be seconds, minutes or hours in the future, depending upon the event, the session activity and the circumstances. Additional software users 10 from the user pool are free to join the participants of the session activity at any time.

As a software user 10 joins the session activity, the details for the execution of the crowd event are automatically downloaded to that user's mobile cellular device 12 or are recalled from a memory within the mobile cellular device 12. See Block 56. Each of the software users 10 who selected to participate now has a time synchronized device, an executable session activity program ready to run, and an exact time to start the session activity program.

Once the selected time for the session arrives, the executable programs on each of participating user's mobile cellular devices 12 start in near perfect time synchronization. See Block 58. Accordingly, the mobile cellular devices 12 will, change color, flash, vibrate and/or broadcast sound in a synchronized manner. Any slight error in synchronization will be so slight as to be incomprehensible by the eyes or ears of the software users 10. The simultaneous execution enables the mobile cellular devices 12 to achieve effects that previously were unobtainable.

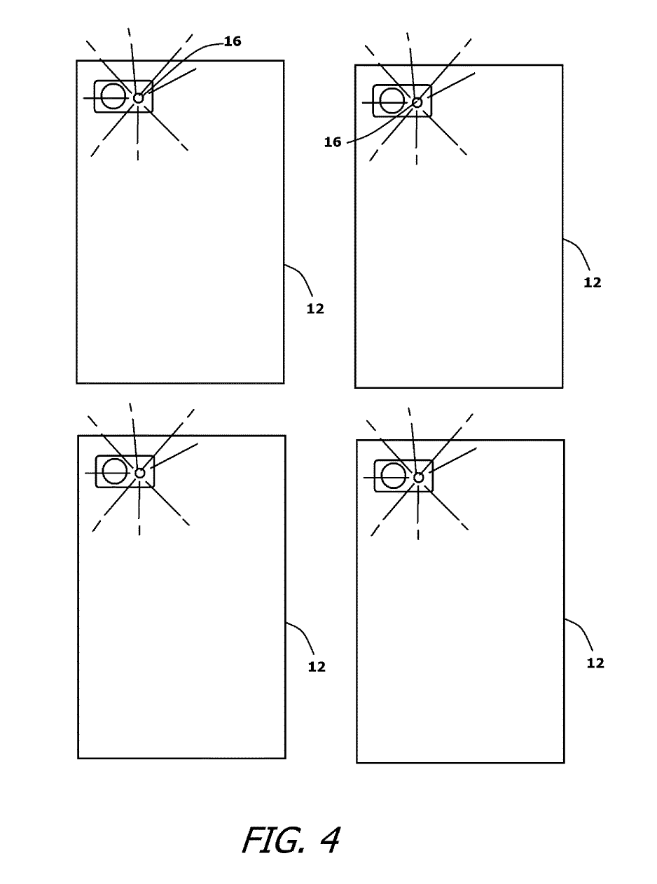

Referring to FIG. 4 in conjunction with FIG. 1, it can be seen that a person can send an executable command to all the mobile cellular devices 12 in the participating group of users 10 to flash the camera flash 16 of each mobile cellular device 12 at the exact same instance. This would create a gigantic flash in a stadium or other such communal gathering. Likewise, the flashes 16 of the mobile cellular devices 12 can be flashed in a propagating sequence, to create an orchestrated light show within the participating software users 10.

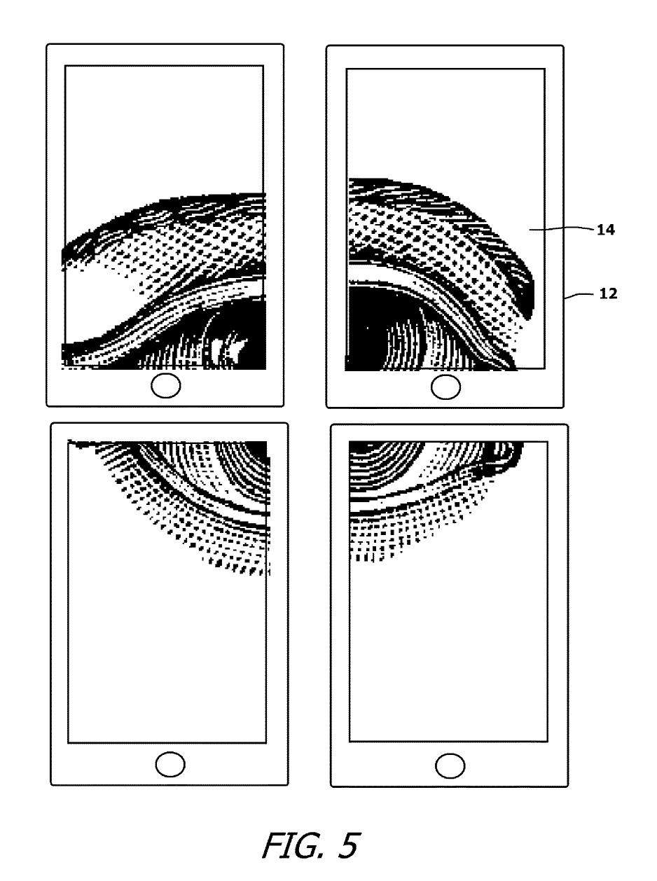

Referring to FIG. 5 in conjunction with FIG. 1, it can be seen that the various display screens 14 of the cell phones 12 of the participating crowd can be used as pixels to create a large digitized display. The images are synchronized and can be altered to display video images over a wide area, wherein the overall image size would be the overall area occupied by the participating software users 10.

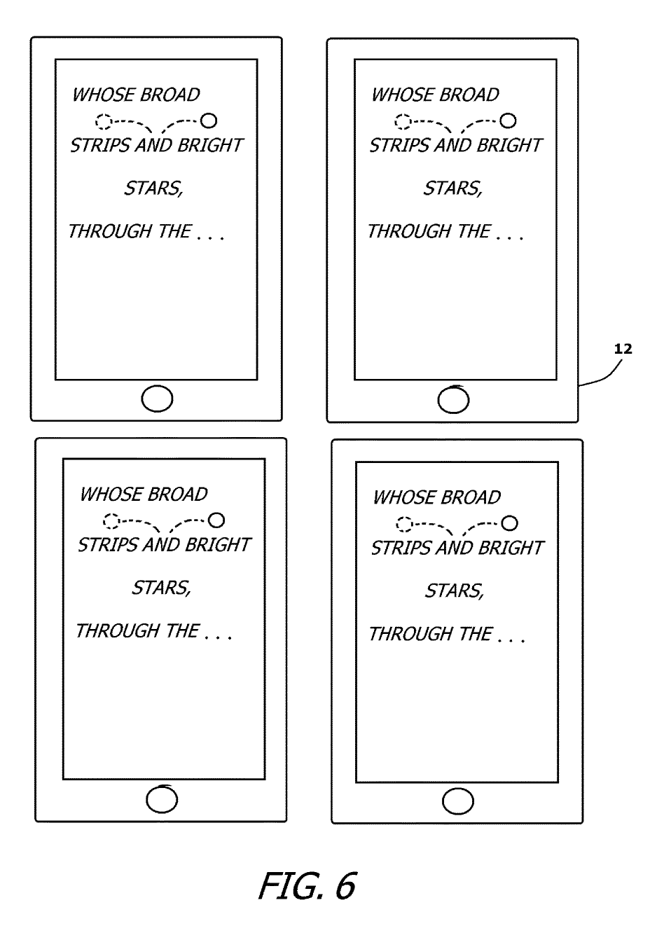

Referring to FIG. 6 in conjunction with FIG. 1, it can be seen that the executable program can cause instructions, lyrics, and/or music to appear and/or be played on each mobile cellular device 12 in full synchronization. This would enable the software users 10 to sing together, pray together, dance together, or otherwise perform synchronized activities without concern for the physical location of the software users 10. Accordingly, the synchronized session activity can be maintained even if the participating software users 10 are widely geographically dispersed. For example, a prayer vigil can be established, where people all over the world pray the exact same prayer in perfect synchronization.

For some session activities, the placement of each of the software users 10 in a crowd must be known. For example, if the display screens 16 of the mobile cellular devices 12 are being used as pixels to create a larger effect or display, the position of each mobile cellular device 12 with respect to the others needs to be known. In such a scenario, a software user 10 may have to enter a stadium seat number or similar locator into the mobile cellular device 12 when they accept the session activity offered. In outdoor locations, each mobile cellular device 12 may receive a different executable program depending upon the GPS coordinates detected by the remote cellular device 12.

Additionally, the session activity can be coordinated with broadcasts, such as television broadcasts, radio broadcasts, internet broadcasts, and the like. The system and software can take into account transmission delays to different geographical areas. In this manner, the response from software users 10 can be synchronized even though the broadcast to the users 10 is not.

The software application 20 can also help to physically congregate software users 10 together prior to triggering an event. The system and software can read data from user devices that have GPS and/or cellular location abilities. The location data can be shown to all subscribing software users 10 on a mapping interface. This enables users to view the locations of user congregations so that they can join with the congregation.

The executable program for a session activity enables any software users 10 to send images, videos, audible tracks, texts and the like to followers. However, the data sent cannot be saved or reproduced. Rather, it is utilized by the software application 20 when the session activity is triggered. The time that the session activity is triggered is determined by the person who sends the data, not by the user who receives the data.

It will be understood that the embodiment of the present invention that is illustrated and described is merely exemplary and that a person skilled in the art can make many variations to that embodiment. All such embodiments are intended to be included within the scope of the present invention as defined by the claims.

What is claimed is:

1. A method of operating a plurality of mobile cellular devices held by different users in a synchronized manner, wherein each of said plurality of mobile cellular devices has a system clock, a display screen, a camera flash, and communicates with a communications network, said method comprising the steps of:
loading a software application onto each of said plurality of mobile cellular devices that enable a lead user from among any of said users of said plurality of mobile cellular devices to select an event and to select a session activity to be performed by said plurality of mobile cellular devices during said event;
running said software application in said plurality of mobile cellular devices, wherein upon running said software application, each of said plurality of mobile cellular devices first updates said system clock through said communications network, therein creating improved time synchronization between each said system clock in said plurality of mobile cellular devices;
wherein said software application enables each of said users to agree to participate in said session activity and become part of a user pool;
wherein said software application enables said lead user to set an execution time for said session activity; and
wherein at said execution time, said session activity is performed simultaneously by all of said plurality of mobile cellular devices held by said users in said user pool.

2. The method according to claim 1, wherein said session activity is selected from a group consisting of lighting said display screen and flashing said camera flash.

3. The method according to claim 1, further including the step of displaying a menu of session activities from which said lead user can select said session activity.

4. The method according to claim 1, further including the step of enabling said lead user to create a custom session activity using said software application, which becomes said session activity used by said lead user.

5. A method of operating a plurality of mobile cellular devices held by different users, wherein each of said plurality of mobile cellular devices has a system clock, a display screen, a camera flash, and communicates with a communications network, said method comprising the steps of:
running a software application on each of said plurality of mobile cellular devices that presents a session activity to be performed by said plurality of mobile cellular devices in a time synchronized manner;
updating said system clock for each of said plurality of mobile cellular devices through said communications each time said software application is run, therein creating improved time synchronization between each said system clock in said plurality of mobile cellular devices;
setting an execution time for said session activity;
performing said session activity simultaneously at said execution time by all of said plurality of mobile cellular devices.

6. The method according to claim 5, wherein said software application provides each of said users an option to participate in said session activity.

7. The method according to claim 5, wherein said session activity is selected from a group consisting of lighting said display screen and flashing said camera flash.

8. The method according to claim 5, further including the step of displaying a menu of session activities from which said session activity is selected.

9. The method according to claim 5, further including the step of using said software application to create a custom session activity.

10. A method of operating a plurality of mobile cellular devices, wherein each of said plurality of mobile cellular devices has a system clock, a display screen, a camera flash, and communicates with a communications network, said method comprising the steps of:
running a software application on each of said plurality of mobile cellular devices that presents a session activity to be preformed by said plurality of mobile cellular devices at a specific calendar time;
updating said system clock for each of said plurality of mobile cellular devices through said communications network each time said software application is run, therein creating improved synchronization of calendar time between each said system clock in said plurality of mobile cellular devices;
performing said session activity simultaneously at said calendar time by all of said plurality of mobile cellular devices.

11. The method according to claim 10, wherein said session activity is selected from a group consisting of lighting said display screen and flashing said camera flash.

12. The method according to claim 10, further including the step of displaying a menu of session activities from which said session activity can be selected.

13. The method according to claim 10, further including the step of creating a custom session activity using said software application, which becomes said session activity.
